(19) United States
(12) Patent Application Publication
(10) Pub. No.: US 2024/0193652 A1
(43) Pub. Date: Jun. 13, 2024

(54) RELATIONAL-BASED ONLINE COMMERCE SYSTEM AND METHOD

(71) Applicant: BUDDYING UP PTY LTD, East Perth (AU)

(72) Inventors: Nikola Culum, East Perth (AU); Paulo Reyes Uy, East Perth (AU); Jaydon James Downey, East Perth (AU); Luke Miles Macaulay Evans, East Perth (AU); Miles Cue, East Perth (AU)

(73) Assignee: BUDDYING UP PTY LTD, East Perth, WA (AU)

(21) Appl. No.: 18/554,553

(22) PCT Filed: Mar. 21, 2022
(86) PCT No.: PCT/AU2022/050252

§ 371 Date: Oct. 9, 2023

(30) Foreign Application Priority Data
Apr. 9, 2021 (AU) 2021901048

(51) Int. Cl. G06Q 30/0601; G06Q 10/087; G06Q 20/08; G06Q 20/12

(52) U.S. Cl. CPC G06Q 30/0609; G06Q 10/087; G06Q 20/0855; G06Q 20/12; G06Q 30/0641

(57) ABSTRACT

An administration server configured to define an ecommerce marketplace accessible via the Internet by means of a marketplace GUI. Also included is a seller database configured to maintain a plurality of seller profiles each assigned to a seller, each including a virtual seller shop within the ecommerce marketplace for listing goods and/or services provided by, and available from, a particular seller. Also included is a goods and/or services database configured to maintain a record of goods and/or services provided by a particular seller across the marketplace, and a payment facility configured to accept online payment from a buyer for goods and/or services purchased from a particular seller shop. Each seller profile allows selective listing of goods and/or services provided by another seller as part of goods and/or services available from that particular seller's shop, so that goods and/or services provided by one seller is available from other sellers.

### TECHNICAL FIELD

This invention relates to a computer-implemented method for relational-based online commerce or ‘ecommerce’, and an associated system for relational-based online commerce.

### BACKGROUND ART

The following discussion of the background art is intended to facilitate an understanding of the present invention only. The discussion is not an acknowledgement or admission that any of the material referred to is or was part of the common general knowledge as at the priority date of the application.

In today's highly connected society, buying and selling of products and/or services are easily done from the comfort of home via the Internet using computing devices like desktop computers, laptops, tablets and/or mobile phones. The proliferation of Internet enabled devices has enabled a large part of the world population to be connected to the Internet. As of the year 2020, there is estimated to be more than ten billion Internet enabled devices connected to the Internet.

Online selling or ecommerce has been around since the Internet has been made available to the public. Many entrepreneurs have ventured into online selling and made billions of dollars doing so, including platforms that have become household names and are in use by millions of people daily. While such online ecommerce abounds, it remains a challenge to those who are just starting to offer goods and/or services online to establish an online presence, especially when competing with the larger ecommerce organisations.

In addition, such conventional online transactions tend to be transactional exchanges. In general, where relational exchanges tend to emphasize a long-term orientation, transactional exchanges have a short-term orientation. Unlike transactional exchanges, relational exchanges are generally characterised by attributes such as trust, commitment, and dependence, among others. Conventional brick-and-mortar stores could historically leverage such relational exchanges when providing goods and/or services by focusing on direct relationships with customers. However, the move to ecommerce has generally seen the disappearance of relational exchanges in ecommerce.

As an example of a conventional transactional exchange, consider a single mother needing a new car. A transactional sale will involve getting her to buy a more expensive vehicle with unnecessary and expensive features she does not need in order to maximise the sale. In such an example, she may be coerced into buying a vehicle and is left feeling stressed about how much money she just spent. In contrast, a relational exchange would involve a salesperson speaking with the customer and understanding her situation and needs, and then selling her a vehicle that fits her needs and budget, thereby creating a sense of appreciation and trust. This appreciation leads to the customer telling her friends and family about the dealership and the salesperson that helped her, she may also make a recommendation on social media, and goes back to the same store to get service and will return to that salesperson in the future. As such, the long-term benefits to the store are much larger than the single transactional sale, and both buyer and seller benefit.

In today's technology driven world, an experience with a business, whether positive or negative, is no longer restricted to only word-of-mouth—it can be online for the world to see within minutes, which directly affects future business. The rise of social media platforms means ecommerce companies that focus only on transactional exchanges may struggle, whereas companies and individuals who practice relational selling will experience higher levels of success than those that don't.

The present invention was conceived with the goal in mind of facilitating smaller sellers with entering into ecommerce, as well as promoting relational exchanges between sellers and buyers to benefit both such sellers and buyers in the long term.

### SUMMARY OF THE INVENTION

The skilled addressee is to appreciate that reference herein to ‘the Internet’ generally refers to any suitable communications network and typically includes reference to a global system of interconnected computer networks that use the Internet protocol suite (TCP/IP) to link processing devices worldwide. Such a network typically includes a network of networks that may consist of private, public, academic, business, and government networks of local to global scope, linked by a broad array of electronic, wireless, and optical networking technologies. In this context, the Internet carries a vast range of information resources and services, such as the inter-linked hypertext documents and applications of the World Wide Web (WWW), electronic mail, telephony, and file sharing.

It is also to be understood that reference herein to a ‘GUI’ refer to a Graphical User Interface, being a user interface that allows a user to interact with an electronic device, such as a terminal, processing or computing system through manipulation of graphical icons, visual indicators, text-based typed command labels and/or text navigation, including primary and/or secondary notations, as is known in the art of computer science.

The skilled addressee is further to appreciate that reference herein to a ‘society’ broadly refers to any organised group of persons associated together for educational, religious, benevolent, cultural, scientific, political, patriotic, sporting, or other purposes. For example, a sporting club, a school, and a not-for-profit charity are all examples of a society as described herein.

In addition, reference herein to goods and/or services ‘provided’ by a seller is to be understood as goods and/or services produced and/or supplied by such a seller, i.e. a source of such goods and/or services; whereas goods and/or services ‘available’ from a seller is to be understood as being obtainable from such a seller, i.e. the seller does not necessarily produce or supply such goods and/or services themselves, but it is available from them, e.g. a reseller.

According to a first aspect of the invention there is provided a system for relational-based online commerce, said system comprising:
an administration server configured to define a virtual ecommerce marketplace accessible via the Internet by means of a marketplace GUI;
a seller database configured to maintain a plurality of seller profiles each assigned to a pre-registered seller, each seller profile including a virtual seller shop within the ecommerce marketplace for listing goods and/or services provided by, and available from, a particular seller;
a goods and/or services database configured to maintain a record of goods and/or services provided by a particular seller across the marketplace; and
a payment facility configured to accept online payment from a buyer for goods and/or services purchased from a particular seller shop;
wherein each seller profile allows selective listing of goods and/or services provided by another seller as part of goods and/or services available from that particular seller's shop;
wherein the goods and/or services database is configured to monitor inventory of goods and/or services provided by and available from respective sellers across the marketplace; and
wherein the payment facility is configured to allocate received payment from buyers to sellers according to such provision and availability of purchased goods and/or services, so that goods and/or services provided by one seller is available from other sellers, and selective listing of goods and/or services facilitates relational exchanges between respective sellers and buyers.

Typically, the system includes a buyer database configured to maintain a plurality of buyer profiles.

In an embodiment, the administration server is configured to pre-register a buyer profile on said buyer database, the buyer profile including details selected from a non-exhaustive group consisting of buyer name, buyer address, payment details, purchase preferences, history of purchases and preferred seller shops.

Typically, the administration server is configured to provide multi-level access to a seller and/or buyer profile by means of different authentication levels, each level of access allowing access to increasing levels of personal and/or sensitive information.

In an embodiment, the different authentication levels comprise a) a basic level accessible via the provision of a username and password combination; b) a standard level accessible via the provision of a username and password combination along with an access code sent to a device registered to said profile; and c) an enhanced level accessible via the provision of multi-factor authentication protocols.

Typically, the multi-factor authentication protocol includes a knowledge factor, such as a password or pin, as well as a possession factor, i.e. a security token, an inherence factor, i.e. a biometric identifier, and/or a location factor, i.e. a GNSS location.

In an embodiment, the marketplace is used to promote and sell goods and/or services of a particular society.

Typically, each seller profile is customisable to provide a user-definable virtual seller shop within the ecommerce marketplace.

In an embodiment, the marketplace GUI provided by the administration server includes a communications module configured to arrange a potential buyer of services in communication with a seller from which such services are available.

Typically, the communications module includes an online chat, voice and/or video call communications channel whereby a buyer and seller are able to finalise service-specific requirements prior to payment.

Typically, the goods and/or services database is configured to monitor inventory of goods and/or services provided by and available from respective sellers across the marketplace to ensure the same goods and/or services are not sold multiple times.

Accordingly, the administration server is typically configured to automatically update the ecommerce marketplace in accordance with the goods and/or services database after a purchase.

Typically, each seller profile listing goods and/or services provided by, and available from, that particular seller is updateable to reflect promotions and/or discounts.

Typically, the selective listing of goods and/or services provided by another seller includes the ability to selectively list promotions and/or discounts.

Typically, the payment facility comprises an online funds transfer portal, i.e. credit card payment facility, digital currency exchange, etc.

Typically, the payment facility is configured to allocate received payment to sellers according to provision and availability of such purchased goods and/or services so that a seller which provides a good and/or service receives a majority share of said payment, and a seller from which the good and/or service is purchased, i.e. available from, receives a minority share.

Typically, the majority and minority shares are predetermined.

Typically, the payment facility is configured to allocate a predetermined portion of any received payment to said administration server, i.e. a commission for providing the marketplace.

In an embodiment, the administration server includes the seller database, the goods and/or services database and the payment facility.

According to a second aspect of the invention there is provided a computer-implemented method for relational-based online commerce, said method comprising the steps of:
defining, by means of an administration server, a virtual ecommerce marketplace accessible via the Internet by means of a marketplace GUI;
maintaining, in a seller database, a plurality of seller profiles each assigned to a pre-registered seller, each seller profile including a virtual seller shop within the ecommerce marketplace for listing goods and/or services provided by, and available from, a particular seller;
maintaining, in a goods and/or services database, a record of goods and/or services provided by a particular seller across the marketplace;
selectively listing, via each seller profile, goods and/or services provided by other sellers as part of goods and/or services available from that particular seller's shop;
monitoring, via the goods and/or services database, inventory of goods and/or services provided by and available from respective sellers across the marketplace;
accepting online payment, via a payment facility, from a buyer for goods and/or services purchased from a particular seller shop; and
allocating, via the payment facility, received payment to sellers according to provision and availability of such purchased goods and/or services, so that goods and/or services provided by one seller is available from other sellers, and selective listing of goods and/or services facilitates relational exchanges between respective sellers and buyers.

Typically, the method includes the step of maintaining, via a buyer database, a plurality of buyer profiles.

In an embodiment, the method includes the step of pre-registering, via the administration server, a buyer profile on said buyer database, the buyer profile including details selected from a non-exhaustive group consisting of buyer name, address, details, buyer payment purchase preferences, history of purchases and preferred seller shops.

Typically, the method includes the step of providing multi-level access to a seller and/or buyer profile, via the administration server, by means of different authentication levels, each level of access allowing access to increasing levels of personal and/or sensitive information.

In an embodiment, the different authentication levels comprise a) a basic level accessible via the provision of a username and password combination; b) a standard level accessible via the provision of a username and password combination along with an access code sent to a device registered to said profile; and c) an enhanced level accessible via the basic level username and password along with the provision of multi-factor authentication protocols.

Typically, the multi-factor authentication protocol includes a knowledge factor, such as a password or pin, as well as a possession factor, i.e. a security token, an inherence factor, i.e. a biometric identifier, and/or a location factor, i.e. a GNSS location.

In an embodiment, the marketplace is used to promote and sell goods and/or services of a particular society.

Typically, each seller profile is customisable to provide a user-definable virtual seller shop within the ecommerce marketplace.

In an embodiment, the method includes the step of arranging, via a communications module of the administration server, a potential buyer of services in communication with a seller from which such services are available.

Typically, the communications module includes an online chat, voice and/or video call communications channel whereby a buyer and seller are able to finalise service-specific requirements prior to payment.

Typically, the step of monitoring goods and/or services is performed to ensure the same goods and/or services are not sold multiple times by different sellers.

Accordingly, the method includes the step of automatically updating, via the administration server, the ecommerce marketplace in accordance with the goods and/or services database after a purchase.

Typically, each seller profile listing goods and/or services provided by, and available from, that particular seller is updateable to reflect promotions and/or discounts.

Typically, the selective listing of goods and/or services provided by another seller includes the ability to selectively list promotions and/or discounts.

Typically, the payment facility comprises an online funds transfer portal, i.e. credit card payment facility, digital currency exchange, etc.

Typically, the payment facility is configured to allocate received payment to sellers according to provision and availability of such purchased goods and/or services so that a seller which provides a good and/or service receives a majority share of said payment, and a seller from which the good and/or service is purchased, i.e. available from, receives a minority share.

Typically, the majority and minority shares are predetermined.

Typically, the payment facility is configured to allocate a predetermined portion of any received payment to said administration server, i.e. a commission for providing the marketplace.

According to a third aspect of the invention there is provided a computer programme product which, when executed by a suitable processing system, facilitates the performance of the method according to the second aspect of the invention above.

According to a further aspect of the invention there is provided a computer-implemented method for relational-based online commerce and an associated system for relational-based online commerce, substantially as herein described and/or illustrated.

### BRIEF DESCRIPTION OF THE DRAWINGS

The description will be made with reference to the accompanying drawings in which:

FIG. 1 is a diagrammatic overview representation of one example of a system for relational-based online commerce, in accordance with aspects of the present invention;

FIG. 2 illustrates a functional block diagram of an example processing system that can be utilised to embody or give effect to a particular embodiment of the administration server and/or user devices of the system of FIG. 1;

FIG. 3 illustrates an example network infrastructure that can be utilised to embody or give effect to a particular embodiment of a communications network whereby the administration server can be arranged in signal communication with sellers and buyers; and

FIG. 4 is a functional block diagrammatic representation of method steps for a computer-implemented method for relational-based online commerce, in accordance with aspects of the present invention.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

For example, layout of webpages representative of GUIs, specifics of Application Programming Interfaces (APIs) interfaces between applications, communications protocols, etc. are well-understood within the art of computer engineering and will not be described in any specific detail other than to provide enabling disclosure to the skilled addressee.

Broadly, the present invention provides for a system 10 for relational-based online commerce. Such system 10 broadly comprises an administration server 12 (described in more detail below) arranged in communication via network 200, typically the Internet, with buyers 32 and sellers 30 using suitable devices or processing systems 34 and 36, respectively.

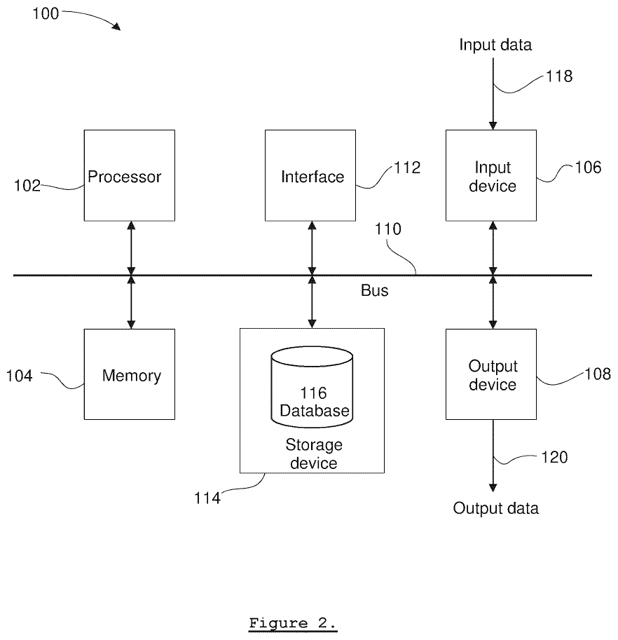

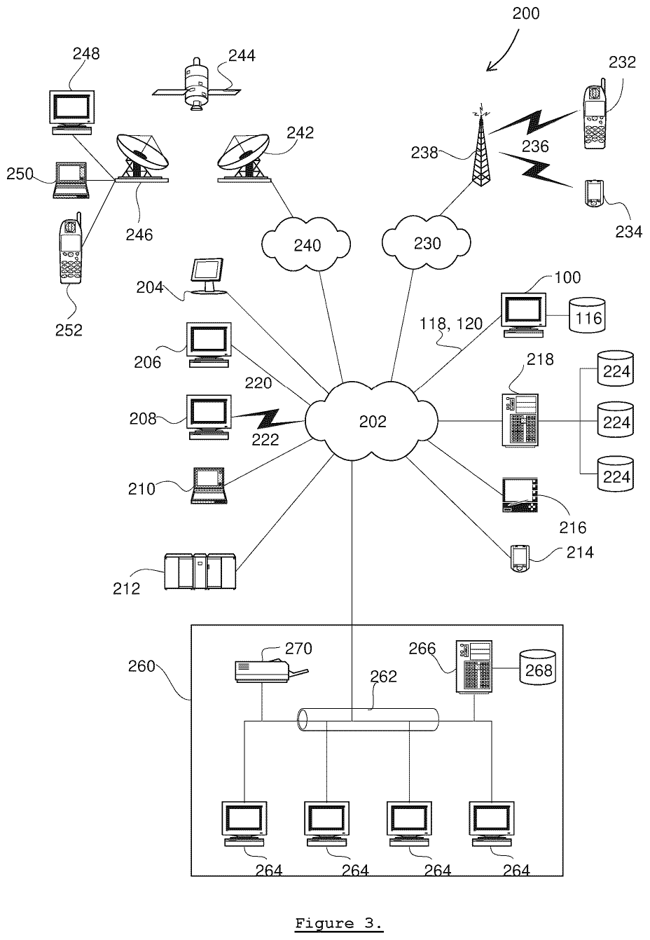

Accordingly, with reference firstly to FIGS. 2 and 3 of the accompanying drawings, there is shown a broad example of a processing system 100 that can be used, in different configurations as will be readily apparent to the skilled addressee, to implement buyer and seller devices 34 and 36, as well as administration server 12, as described in more detail below. Similarly, FIG. 3 shows a broad example of a networked communications system 200 whereby the respective processing and computer systems can be arranged in signal communication.

It is to be appreciated that any reference herein to “means” specifically includes any one or more of a computer programme product for use in a local or dispersed computing system, a computer readable modulated carrier signal for interpretation by a local or dispersed computing system, or a computer readable medium of instructions for enabling a local or dispersed computing system to provide such “means” within the context of the description. In addition, such “means” may further expressly comprise any of the hardware and/or software components, independently or in combination, provided for in the description below, as will be understood by the skilled addressee.

As is known in the art of computer programming, an application programming interface (API) is a set of subroutine definitions, communication protocols, and tools for building software. In general terms, it is a set of clearly defined methods of communication among various components. Means for facilitating any of the communications or interactions between the administration server 12 and the buyer and seller devices 34 and 36 may be facilitated via suitable APIs within processing system 100 or network 200, as will be readily apparent to the skilled addressee.

By way of further broad background, in a general networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or satellite telephone, mobile data terminal, portable computer, Personal Digital Assistant (PDA), pager, thin client, tablet, or any other similar type of digital electronic device. The capability of such a terminal to request and/or receive information or data can be provided by software, hardware and/or firmware. A terminal may include or be associated with other devices, for example a local data storage device such as a hard disk drive or solid-state drive.

An information source can include a server, or any type of terminal, that may be associated with one or more storage devices that are able to store information or data, for example in one or more databases residing on a storage device. The exchange of information (i.e. the request and/or receipt of information or data) between a terminal and an information source, or other terminal (s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The Internet, which often serves as an enabling part of communications network 200, the is large-scale interconnection of public and private networks. The network infrastructure can include devices such as a telephone switch, base station, bridge, router, or any other such specialised network component, which facilitates the connection between a terminal and an information source. Collectively, an interconnected group of terminals, communication means, infrastructure and information sources is referred to as a network. The network itself may take a variety of forms. For example, it may be a computer network, telecommunications network, data communications network, Local Area Network (LAN), Wide Area Network (WAN), wireless network, Internetwork, Intranetwork, the Internet and developments thereof, transient or temporary networks, combinations of the above or any other type of network providing for communication between computerised, electronic or digital devices. More than one distinct network can be provided, for example a private and a public network. A network as referenced in this specification should be taken to include any type of terminal or other similar type of electronic device, or part thereof, which is rendered such that it is capable of communicating with at least one other terminal.

One example of facilitating communication across such networks, is the Hyper-Text Mark-Up Language (HTML) and Hyper-Text Transfer Protocol (HTTP), and developments thereof, which have made the Internet or World Wide Web (WWW) very accessible. The exchange of information on the Internet is further facilitated through hyper-text documents. Hyper-Text documents are unique in that they use tags to define links which, when selected, retrieve the related information from within the same document or from a new document altogether. The links are defined using HTML which provides a document formatting method which adapts in a consistent manner to any computer on which it is displayed. HTML tags are used to define various components of text, visual or audio which make up a hyper-text document, including such things as formatting and linking to other documents. HTML tags which link documents on one Internet information source to those on another do so by associating a Uniform Resource Locator (URL) with the referenced information. The skilled addressee will appreciate that other communication protocols may be used and are within the scope of the present invention.

In light of this background, the processing system 100 of FIG. 2 generally includes at least one processor 102, or processing unit or plurality of processors, memory 104, at least one input device 106 and at least one output device 108, coupled together via a bus or group of buses 110. Typically, the processor 102 comprises any suitable processor or microcontroller configured to receive input, perform logical and arithmetical operations on a suitable instruction set, and provide output, as well as transitory and/or non-transitory electronic storage, such as memory 104 and storage device 114, or the like.

In certain embodiments, input device 106 and output device 108 could be the same device, e.g. a touchscreen. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could include more than one distinct processing device, for example to handle different functions within the processing system 100.

Input device 106 receives input data 118 and can include, for example, a keyboard, a pointer device such as a pen-like device or a mouse, audio receiving device for voice-controlled activation such as a microphone, data receiver or antenna such as a modem or wireless data adaptor, data acquisition card, a touchscreen for receiving tactile input, etc. Input data 118 could come from different sources, for example keyboard instructions in conjunction with data received via a network, or a dedicated global navigation satellite system (GNNS) sensor, as is known in the art, or the like. Output device 108 produces or generates output data 120 and can include, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network.

A user could view data output, or an interpretation of the data output, on, for example, a touchscreen, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. The processor 102 receives instructions as input data 118 via input device 106 and can display processed results or other output to a user by utilising output device 108. More than one input device 106 and/or output device 108 can be provided. It should be appreciated that the processing system 100 may be any form of terminal, server, specialised hardware, or the like.

As described, the processing system 100 is generally part of a networked communications system 200, as shown in FIG. 3. Processing system 100 could connect to network 202, for example the Internet or a WAN. Input data 118 and output data 120 could be communicated to other devices via network 202. Other terminals, for example, thin client 204, further processing systems 206 and 208, notebook computer 210, mainframe computer 212, PDA 214, pen-based computer 216, server 218, etc., can be connected to network 202. A large variety of other types of terminals or configurations could be utilised. The transfer of information and/or data over network 202 can be achieved using wired communications means 220 or wireless communications means 222. Server 218 can facilitate the transfer of data between network 202 and one or more databases 224. Servers 218 and 266 and one or more databases 224 provide an example of the administration server 12, for example.

Other networks may communicate with network 202. For example, telecommunications network 230 could facilitate the transfer of data between network 202 and mobile or cellular telephone 232 or a PDA-type device 234, by utilising wireless communication means 236 and receiving/transmitting station 238. Satellite communications network 240 could communicate with satellite signal receiver 242 which receives data signals from satellite 244 which in turn is in remote communication with satellite signal transmitter 246. Terminals, for example further processing system 248, notebook computer 250 or satellite telephone 252, can thereby communicate with network 202. A local network 260, which for example may be a private network, LAN, etc., may also be connected to network 202. For example, network 202 could be connected with Ethernet 262 which connects terminals 264, server 266 which controls the transfer of data to and/or from database 268, and printer 270. Various other types of networks could be utilised.

The processing system 100 is adapted to communicate with other terminals, for example further processing systems 206, 208, by sending and receiving data, 118, 120, to and from the network 202, thereby facilitating possible communication with other components of the networked communications system 200. Thus, for example, the networks 202, 230, 240 may form part of, or be connected to, the Internet, in which case, the terminals 206, 212, 218, for example, may be web servers, Internet terminals or the like. The networks 202, 230, 240, 260 may be or form part of other communication networks, such as LAN, WAN, Ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

Accordingly, in the manner described above, administration server 12 and the buyer and seller devices or processing systems 34 and 36 are generally realised by suitable versions of the processing system 100, as described above, and networked together via network arrangement 200, typically the Internet, to perform the functions and provide the features of the invention broadly described herein. The skilled addressee is to appreciate that variations hereon are possible, expected and within the scope of the present invention.

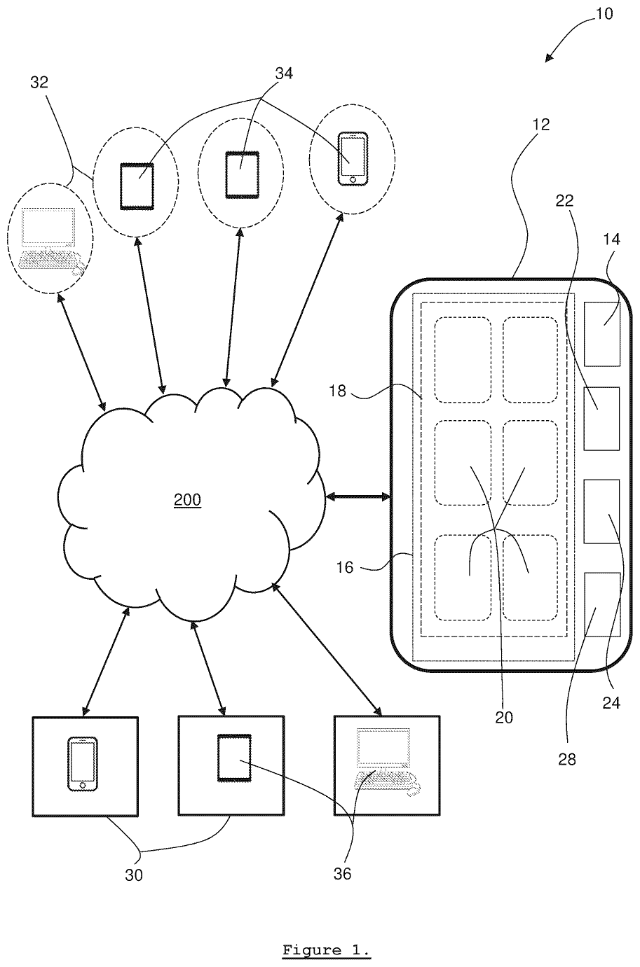

With the above general background established, an embodiment of the system 10 for relational-based online commerce is diagrammatically represented in FIG. 1. Broadly, an embodiment of the system 10 generally comprises the administration server 12 which is configured to define a virtual ecommerce and online, i.e. web-accessible marketplace 16. Such marketplace 16 is generally accessible via the Internet 200 by means of a marketplace GUI 18 displayable on buyer and/or seller devices 34 and 36, as is known in the art.

The system 10 also includes, typically but not necessarily part of administration server 12, a seller database 14 which is configured to maintain a plurality of seller profiles 20 each assigned to a pre-registered seller 30. Each seller profile 20 includes a virtual seller shop (also indicated by reference numeral 20) within the ecommerce marketplace 16 on which goods and/or services provided by, and available from, a particular seller can be listed for sale. Typically, each seller profile 20 is customisable to provide a user-definable virtual seller shop within the ecommerce marketplace 16.

Similarly, the system 10 may also include a buyer database (not shown) which is configured to maintain a plurality of buyer profiles, similar to seller database 14. In an embodiment, the administration server 12 is configured to pre-register a buyer profile 20 on said buyer database, the buyer profile including details selected from a non-exhaustive group consisting of buyer name, buyer address, payment details, purchase preferences, history of purchases and preferred seller shops.

In a typical example, the administration server 12 is configured to provide multi-level access to a seller and/or buyer profile by means of different authentication levels, with each level of such multi-level access allowing access to increasing levels of personal and/or sensitive information.

In an embodiment, the different authentication levels comprise a basic level, a standard level and an enhanced level of access, for example. In such an embodiment, the basic level of access may be accessible via the provision of a username and password combination from a buyer or seller. At the basic level of access, a status of purchases and shipping updates may be accessible, i.e. no sensitive information.

Similarly, the standard level may be accessible via the provision of a username and password combination from a buyer or seller, along with an access code sent from the administration server 12 to a device registered to said profile. For example, a buyer or seller 30 or 32 may provide a username and password for a profile, after which the administration server 12 sends an access code to a mobile phone registered to that specific profile. If the buyer or seller then enters the access code within a specific time window, such as 5 minutes, a standard level of access is provided. At the standard level of access, personal information of the buyer or seller may be accessed and updated, such as addresses, names, etc.

Lastly, the enhanced level may be accessible via the provision of multi-factor authentication protocols. Such multi-factor authentication protocols may include a knowledge factor, such as a username and password/pin combination, as well as a possession factor, i.e. a security token, an inherence factor, i.e. a biometric identifier, and/or a location factor, i.e. a GNSS location. At the enhanced level, sensitive information of the profile may be accessible, such as banking information, security information, etc. The skilled addressee is to appreciate that variations hereon are possible, expected and expressly included within the scope of the present invention.

The system 10 also includes, typically but not necessarily part of administration server 12, a goods and/or services database 22 which is configured to maintain a record of goods and/or services provided by a particular seller across the marketplace 16. The goods and/or services database 22 is generally configured to monitor inventory of goods and/or services provided by, and available from, respective sellers 30 across the marketplace 16 to ensure that the same goods and/or services are not sold multiple times, as described below.

The system 10 also includes, typically but not necessarily part of administration server 12, a payment facility 24 which is configured to accept online payment from a buyer 32 for goods and/or services purchased from a particular seller shop 20. Typically, the payment facility 24 comprises an online funds transfer portal, i.e. credit card payment facility, digital currency exchange, etc. As is known in the art of online commerce, the payment facility 24 is generally configured to allocate received payment to sellers 30 according to provision and availability of purchased goods and/or services sold on the marketplace 16. Additionally, the payment facility 24 is generally configured to allocate a predetermined portion of any received payment to said administration server, i.e. a commission for providing the marketplace.

Importantly, each seller profile 20 generally allows selective listing of goods and/or services provided by another seller as part of goods and/or services available from that particular seller's shop, so that goods and/or services provided by one seller is available from other sellers, and such selective listing of goods and/or services facilitates relational exchanges between respective sellers and buyers.

In an embodiment, the marketplace 16 is used to promote and sell goods and/or services of a particular society. For example, members of a club may establish a marketplace 16 via administration server 12, wherein each member of the club is assigned a seller profile 20 with associated customisable seller shop. Each member provides different goods and/or services, such as kitchenware, plumbing services, mechanic services, foodstuffs, etc.

Different members may selectively list goods and/or services of other members of their choosing for sale on their own online seller shops 20 accessible via global marketplace or sales ecosystem 16. Buyers 32 are then able to peruse such listed goods and/or services online, with selected goods and/or services available from sellers even where they are not directly provided by such seller.

In an embodiment, for services provided and available, the marketplace GUI 18 provided by the administration server 12 may include a communications module 28 which is configured to arrange a potential buyer 32 of services in communication with a seller 30 from which such services are available or provided by. Typically, the communications module 28 includes an online chat, voice and/or video call communications channel whereby a buyer and seller are able to finalise service-specific requirements prior to payment. For example, such communications module 28 provides a functionality that allows a buyer to communicate with the seller in real-time. Such communication is generally available for a limited time during an order placement and is automatically closed subject to various conditions, such as cancellation or purchase, completion of service provision, length of time use, and project timeline relevance.

In addition, each seller profile 20 listing goods and/or services provided by, and available from, that particular seller is typically updateable to reflect promotions and/or discounts. Similarly, the selective listing of goods and/or services provided by another seller includes the ability to selectively list such promotions and/or discounts, as relevant.

Given the relational nature of the system 10 which allows selective listing of other sellers' goods and/or services, the payment facility 24 is typically configured to allocate received payment to sellers according to such provision and availability of the purchased goods and/or services so that a seller which provides a good and/or service receives a majority share of said payment, and a seller from which the good and/or service is purchased, i.e. available from, receives a minority share. Such majority and minority shares are predetermined, i.e. agreed to before commencement of selective listing. In addition, the administration server 2 is typically configured to automatically update the ecommerce marketplace 16 in accordance with the goods and/or services database 22 after a purchase to ensure that the same good and/or service is not listed after being sold.

In addition, payment facility 24 may be configured to allocate a portion of any received payment from a buyer to the administration server 12, i.e. a commission for providing the marketplace 16. In this manner, with reference to the above example club or other society establishes the marketplace 16, the society itself is able to benefit from the transactions by its members, i.e. sellers. As above, such portion of payment to the administration server 12 is generally predetermined, i.e. terms and conditions of using the marketplace, or the like. Again, variations hereon are possible and within the scope of the present invention.

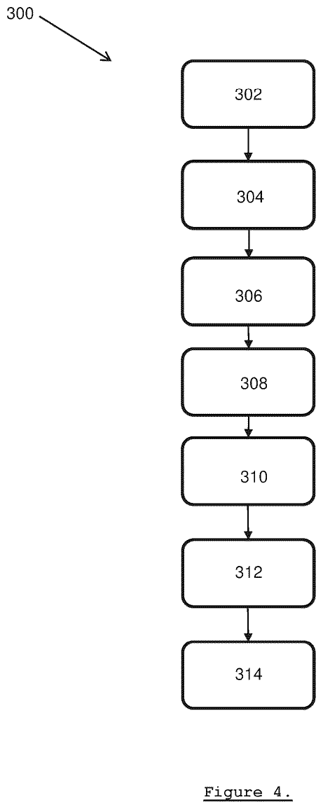

With reference now to FIG. 4 of the accompanying drawings, there is shown representative method steps of an associated computer-implemented method 300 for relational-based online commerce. Such a method 300 typically comprises the steps of defining 302, by means of an administration server 12, a virtual ecommerce marketplace 16 accessible via the Internet 200 by means of a marketplace GUI 18; and maintaining 304, in a seller database 14, a plurality of seller profiles 20 each assigned to a pre-registered seller 30, each seller profile 20 including a virtual seller shop 20 within the ecommerce marketplace 16 for listing goods and/or services provided by, and available from, a particular seller.

Method 300 further generally includes the further steps of maintaining 306, in a goods and/or services database 22, a record of goods and/or services provided by a particular seller across the marketplace 16; selectively listing 308, via each seller profile 20, goods and/or services provided by other sellers as part of goods and/or services available from that particular seller's shop; and monitoring 310, via the goods and/or services database 22, inventory of goods and/or services provided by and available from respective sellers across the marketplace 16.

Method 300 also includes the steps of accepting 312 online payment, via a payment facility 24, from a buyer 32 for goods and/or services purchased from a particular seller shop 20; and allocating 314, via the payment facility 24, received payment to sellers 30 according to provision and availability of such purchased goods and/or services, so that goods and/or services provided by one seller is available from other sellers, and selective listing of goods and/or services facilitates relational exchanges between respective sellers and buyers.

The skilled addressee is to appreciate that the present invention further includes a computer programme product which, when executed by a suitable processing system 100, examples of which are described above, facilitates the performance of the method 300 described above.

Applicant believes it particularly advantageous that the present invention provides for a system 10 for relational-based online commerce which enhances seller experience, but also provided better selling experience in an online environment where seller are taken into interests consideration while still ensuring customer satisfaction and ease of use of the online store. The system 10 is designed to allow multiple selling opportunities for the sellers 30, thereby increasing the chance of selling more items within an ecosystem that allows sellers synergistically to benefit each other via a marketplace 16 or ecosystem that allows sellers to cooperate, yet also provides better deals for the buyers.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items. No language in the specification should be construed as indicating any non-claimed subject matter as essential to the practice of the claimed subject matter.

It is to be appreciated that reference to “one example” or “an example” of the invention, or similar exemplary language (e.g., “such as”) herein, is not made in an exclusive sense. These examples are intended to assist the skilled person in performing the invention and are not intended to limit the overall scope of the invention in any way unless the context clearly indicates otherwise.

Variations (e.g. modifications and/or enhancements) of one or more embodiments described herein might become apparent to those of ordinary skill in the art upon reading this application. The inventor (s) expects skilled artisans to employ such variations as appropriate, and the inventor (s) intends for the claimed subject matter to be practiced other than as specifically described herein.

Any steps, processes, and operations method described herein are not to be construed as necessarily requiring their performance in the particular order discussed or illustrated, unless specifically identified as an order of performance. It is also to be understood that additional or alternative steps may be employed.

1. A system for relational-based online commerce, said system comprising:
an administration server configured to define a virtual ecommerce marketplace accessible via the Internet by means of a marketplace GUI;
a buyer database configured to maintain a plurality of buyer profiles;
a seller database configured to maintain a plurality of seller profiles each assigned to a pre-registered seller, each seller profile including a virtual seller shop within the ecommerce marketplace for listing goods and/or services provided by, and available from, a particular seller;
a goods and/or services database configured to maintain a record of goods and/or services provided by a particular seller across the marketplace; and
a payment facility configured to accept online payment from a buyer for goods and/or services purchased from a particular seller shop;
wherein each seller profile is customisable to provide a user-definable virtual seller shop within the ecommerce marketplace, and each seller profile allows selective listing of goods and/or services provided by another seller as part of goods and/or services available from that particular seller's shop;
wherein the goods and/or services database is configured to monitor inventory of goods and/or services provided by and available from respective sellers across the marketplace;
wherein the payment facility is configured to allocate received payment from buyers to sellers according to such provision and availability of purchased goods and/or services, so that goods and/or services provided by one seller is available from other sellers, and selective listing of goods and/or services facilitates relational exchanges between respective sellers and buyers; and
wherein the marketplace is used to promote and sell goods and/or services of a particular society.

2. (canceled)

3. The system of claim 1, wherein the administration server is configured to pre-register a buyer profile on said buyer database, the buyer profile including details selected from a non-exhaustive group consisting of buyer name, buyer address, payment details, purchase preferences, history of purchases and preferred seller shops.

4. The system of claim 1, wherein the administration server is configured to provide multi-level access to a seller and/or buyer profile by means of different authentication levels, each level of access allowing access to increasing levels of personal and/or sensitive information wherein the different authentication levels comprise a) a basic level accessible via the provision of a username and password combination; b) a standard level accessible via the provision of a username and password combination along with an access code sent to a device registered to said profile; and c) an enhanced level accessible via the provision of multi-factor authentication protocols, and wherein the multi-factor authentication protocol includes a knowledge factor, such as a password or pin, as well as a possession factor, i.e. a security token, an inherence factor, i.e. a biometric identifier, and/or a location factor, i.e. a GNSS location.

5-7. (canceled)

8. The system of claim 1, wherein the marketplace GUI provided by the administration server includes a communications module configured to arrange a potential buyer of services in communication with a seller from which such services are available and wherein the communications module includes an online chat, voice and/or video call communications channel whereby a buyer and seller are able to finalise service-specific requirements prior to payment.

9. (canceled)

10. The system of claim 1, wherein the goods and/or services database is configured to monitor inventory of goods and/or services provided by and available from respective sellers across the marketplace to ensure the same goods and/or services are not sold multiple times and wherein the administration server is typically configured to automatically update the ecommerce marketplace in accordance with the goods and/or services database after a purchase.

11. (canceled)

12. The system of claim 1, wherein each seller profile listing goods and/or services provided by, and available from, that particular seller is updateable to reflect promotions and/or discounts and wherein the selective listing of goods and/or services provided by another seller includes the ability to selectively list promotions and/or discounts.

13. (canceled)

14. The system of claim 1, wherein the payment facility comprises an online funds transfer portal, i.e. credit card payment facility, digital currency exchange, etc.

15. The system of claim 1, wherein the payment facility is configured to allocate received payment to sellers according to provision and availability of such purchased goods and/or services so that a seller which provides a good and/or service receives a majority share of said payment, and a seller from which the good and/or service is purchased, i.e. available from, receives a minority share and wherein such majority and minority shares are predetermined.

16. (canceled)

17. The system of claim 1, wherein the payment facility is configured to allocate a predetermined portion of any received payment to said administration server, i.e. a commission for providing the marketplace.

18. The system of claim 1, wherein the administration server includes the seller database, the goods and/or services database and the payment facility.

19. A computer-implemented method for relational-based online commerce, said method comprising the steps of:
defining, by means of an administration server, a virtual ecommerce marketplace accessible via the Internet by means of a marketplace GUI;
maintaining, via a buyer database, a plurality of buyer profiles;
maintaining, in a seller database, a plurality of seller profiles each assigned to a pre-registered seller, each seller profile customisable to provide a user-definable virtual seller shop within said ecommerce marketplace, with each virtual seller shop for listing goods and/or services provided by, and available from, a particular seller;
maintaining, in a goods and/or services database, a record of goods and/or services provided by a particular seller across the marketplace;
selectively listing, via each seller profile, goods and/or services provided by other sellers as part of goods and/or services available from that particular seller's shop;
monitoring, via the goods and/or services database, inventory of goods and/or services provided by and available from respective sellers across the marketplace;
accepting online payment, via a payment facility, from a buyer for goods and/or services purchased from a particular seller shop; and
allocating, via the payment facility, received payment to sellers according to provision and availability of such purchased goods and/or services, so that goods and/or services provided by one seller is available from other sellers, and selective listing of goods and/or services facilitates relational exchanges between respective sellers and buyers, wherein the marketplace is used to promote and sell goods and/or services of a particular society.

20. (canceled)

21. The method of claim 19, which includes the step of pre-registering, via the administration server, a buyer profile on said buyer database, the buyer profile including details selected from a non-exhaustive group consisting of buyer name, buyer address, payment details, purchase preferences, history of purchases and preferred seller shops.

22. The method of claim 19, which includes the step of providing multi-level access to a seller and/or buyer profile, via the administration server, by means of different authentication levels, each level of access allowing access to increasing levels of personal and/or sensitive information, wherein the different authentication levels comprise a) a basic level accessible via the provision of a username and password combination; b) a standard level accessible via the provision of a username and password combination along with an access code sent to a device registered to said profile; and c) an enhanced level accessible via the basic level username and password along with the provision of multi-factor authentication protocols and wherein the different authentication levels comprise a) a basic level accessible via the provision of a username and password combination; b) a standard level accessible via the provision of a username and password combination along with an access code sent to a device registered to said profile; and c) an enhanced level accessible via the basic level username and password along with the provision of multi-factor authentication protocols.

23-25. (canceled)

26. The method of claim 19, which includes the step of arranging, via a communications module of the administration server, a potential buyer of services in communication with a seller from which such services are available, wherein the communications module includes an online chat, voice and/or video call communications channel whereby a buyer and seller are able to finalise service-specific requirements prior to payment.

27. (canceled)

28. The method of claim 19, wherein the step of monitoring goods and/or services is performed to ensure the same goods and/or services are not sold multiple times by different sellers and which includes the step of automatically updating, via the administration server, the ecommerce marketplace in accordance with the goods and/or services database after a purchase.

29. (canceled)

30. The method of claim 19, wherein each seller profile listing goods and/or services provided by, and available from, that particular seller is updateable to reflect promotions and/or discounts and wherein the selective listing of goods and/or services provided by another seller includes the ability to selectively list promotions and/or discounts.

31. (canceled)

32. The method of claim 19, wherein the payment facility comprises an online funds transfer portal, i.e. credit card payment facility, digital currency exchange, etc.

33. The method of claim 19, wherein the payment facility is configured to allocate received payment to sellers according to provision and availability of such purchased goods and/or services so that a seller which provides a good and/or service receives a majority share of said payment, and a seller from which the good and/or service is purchased, i.e. available from, receives a minority share and wherein the majority and minority shares are predetermined.

34. (canceled)

35. The method of claim 19, wherein the payment facility is configured to allocate a predetermined portion of any received payment to said administration server, i.e. a commission for providing the marketplace.

36. A computer programme product which, when executed by a suitable processing system, facilitates the performance of the method according claim 19.
